(19) United States
(12) Patent Application Publication
(10) Pub. No.: US 2013/0175022 A1
(43) Pub. Date: Jul. 11, 2013

(54) THERMAL MANAGEMENT SYSTEM FOR BATTERY ELECTRIC VEHICLE

(71) Applicants: Jonathan King, Novi, MI (US); Rick Rajaie, Rochester Hills, MI (US); Richard A. DeVogelaere, Novi, MI (US); Adam J. Naish, Novi, MI (US)

(72) Inventors: Jonathan King, Novi, MI (US); Rick Rajaie, Rochester Hills, MI (US); Richard A. DeVogelaere, Novi, MI (US); Adam J. Naish, Novi, MI (US)

(21) Appl. No.: 13/823,176

(22) PCT Filed: Sep. 15, 2011
(86) PCT No.: PCT/US11/51673

§ 371 Date: Mar. 14, 2013

Related U.S. Application Data
(60) Provisional application No. 61/385,656, filed on Sep. 23, 2010.

(51) Int. Cl. B60H 1/00; B60H 1/03

(52) U.S. Cl. CPC B60H 1/00278; B60H 1/034; B60H 1/00885
USPC 165/202; 165/43; 237/12.3 B; 236/34.5

(57) ABSTRACT

A thermal management system for an electric vehicle includes a motor circuit for cooling a motor circuit thermal load, a cabin heating circuit for heating a cabin heater and a battery circuit for managing the temperature of a battery circuit thermal load. All of these circuits can fluidically communicate with each other and a single radiator can cool the fluid from all of these circuits.

### FIELD OF THE INVENTION

The present invention relates to electric vehicles (i.e., vehicles that are powered at least partly by an electric motor) and more particularly to battery electric vehicles with no internal combustion engine on board.

### BACKGROUND OF THE INVENTION

Electric vehicles offer the promise of powered transportation through the use of electric motors while producing few or no emissions. Some electric vehicles are powered by electric motors only and rely solely on the energy stored in an on-board battery pack. Other electric vehicles are hybrids, and include an internal combustion engine, which may, for example, be used to assist the electric motor in driving the wheels (a parallel hybrid), or which may, for example, be used solely to charge the on-board battery pack, thereby extending the operating range of the vehicle (a series hybrid). In some vehicles, there is a single, centrally-positioned electric motor that powers one or more of the vehicle wheels, and in other vehicles, one or more of the wheels have an electric motor positioned at each driven wheel.

While currently proposed and existing vehicles are advantageous in some respects over internal-combustion engine powered vehicles, there are problems that are associated with some electric vehicles. A particular problem is that their range is typically relatively short as compared to internal combustion engine-powered vehicles. This is particularly true for battery electric vehicles that are not equipped with range extender engines. A reason for this limitation is the weight and cost of the battery packs used to store energy for the operation of such vehicles. It would be beneficial to provide technology that improves the efficiency with which power is used in the operation of the vehicle, so as to improve the range of such vehicles.

### SUMMARY OF THE INVENTION

In a first aspect, the invention is directed to a thermal management system for an electric vehicle. The thermal management system includes a motor circuit for cooling a motor circuit thermal load and a second circuit, which may be, for example, a cabin heating circuit for heating a cabin heater or a battery circuit for managing the temperature of a battery circuit thermal load. The second circuit can be isolated from the motor circuit so that the fluid in the second circuit can be brought to a temperature that is different from the temperature of the fluid in the motor circuit. In a preferred embodiment, a single valve can be moved from a first position wherein fluid flow passes between two of the circuits to a second position wherein the two circuits are fluidically isolated from each other.

In a particular embodiment of the first aspect, the thermal management system includes a motor circuit, a cabin heating circuit for heating a passenger cabin, a motor circuit temperature sensor, and a controller. The motor circuit is configured for cooling a motor circuit thermal load including the traction motor. The motor circuit thermal load has a motor circuit thermal load inlet and a motor circuit thermal load outlet. The motor circuit includes a radiator, a first motor circuit conduit fluidically between the radiator and the motor circuit thermal load inlet, a second motor circuit conduit fluidically between the radiator and the motor circuit thermal load outlet, and a motor circuit pump positioned to pump fluid through the motor circuit. The cabin heating circuit is configured for heat exchange with a cabin heating circuit thermal load which includes a cabin heater for heating the cabin. The cabin heating circuit thermal load has a cabin heating circuit thermal load inlet and a cabin heating circuit thermal load outlet, a first cabin heating circuit conduit fluidically between the motor circuit and the cabin heating circuit thermal load inlet, a second cabin heating circuit conduit fluidically between the cabin heating circuit thermal load outlet and the motor circuit, a third cabin heating circuit conduit fluidically between the second and first cabin heating circuit conduits, a cabin heating circuit heater positioned to heat fluid in the cabin heating circuit, a cabin heating circuit valve positionable in a first position wherein fluid flow between the motor circuit and the cabin heating circuit is substantially prevented and a second position wherein fluid flow between the motor circuit and the cabin heating circuit is permitted, and a cabin heating circuit pump positioned to pump fluid through the cabin heating circuit. The motor circuit temperature sensor is positioned to detect the temperature of fluid in the second motor circuit conduit. The controller is operatively connected to the cabin heating circuit valve, the cabin heating circuit heater and to the cabin heating circuit pump. The controller is programmed such that when the cabin heating circuit thermal load requires heat and the temperature sensed by the motor circuit temperature sensor is sufficiently high the controller turns off the cabin heating circuit heater and moves the cabin heating circuit valve to the second position, and when the cabin heating circuit thermal load requires heat and the temperature sensed by the motor circuit temperature sensor is sufficiently low the controller turns on the cabin heating circuit heater, operates the cabin heating circuit pump and moves the cabin heating circuit valve to the first position.

In another particular embodiment of the first aspect, the thermal management system includes a motor circuit, a battery circuit for controlling the temperature of a battery circuit thermal load which includes at least one battery pack, a motor circuit temperature sensor, and a controller. The motor circuit is configured for cooling a motor circuit thermal load including the traction motor. The motor circuit thermal load has a motor circuit thermal load inlet and a motor circuit thermal load outlet. The motor circuit includes a radiator, a first motor circuit conduit fluidically between the radiator and the motor circuit thermal load inlet, a second motor circuit conduit fluidically between the radiator and the motor circuit thermal load outlet, and a motor circuit pump positioned to pump fluid through the motor circuit. The battery circuit is configured for controlling the temperature of a battery circuit thermal load which includes the at least one battery pack. The battery circuit thermal load has a battery circuit thermal load inlet and a battery circuit thermal load outlet. The battery circuit includes a first battery circuit conduit fluidically between the motor circuit and the battery circuit thermal load inlet, a second battery circuit conduit fluidically between the battery circuit thermal load outlet and the motor circuit, a third battery circuit conduit fluidically between the second battery circuit conduit and the first battery circuit conduit, a battery circuit heater positioned to heat fluid in the battery circuit, a battery circuit valve positionable in a first position wherein fluid flow between the motor circuit and the battery circuit is substantially prevented and a second position wherein fluid flow between the motor circuit and the battery circuit is permitted, and a battery circuit pump positioned to pump fluid through the battery circuit. The motor circuit temperature sensor is positioned to detect the temperature of fluid in the second motor circuit conduit. The controller is operatively connected to the battery circuit valve, the battery circuit heater and to the battery circuit pump. The controller is programmed such that when heating of the battery circuit thermal load is required and the temperature sensed by the motor circuit temperature sensor is sufficiently high the controller turns off the battery circuit heater and moves the battery circuit valve to the second position, and when heating of the battery circuit thermal load is required and the temperature sensed by the motor circuit temperature sensor is sufficiently low the controller turns on the battery circuit heater, operates the battery circuit pump and moves the battery circuit valve to the first position.

In a second aspect, the invention is directed to a thermal management system for an electric vehicle. The thermal management system includes a motor circuit for cooling a motor circuit thermal load, a cabin heating circuit for heating a cabin heater and a battery circuit for managing the temperature of a battery circuit thermal load. All of these circuits can fluidically communicate with each other and a single radiator can cool the fluid from all of these circuits. In a preferred embodiment, the system includes a main cooling circuit which includes a compressor and a condenser.

In a particular embodiment of the second aspect, the thermal management system includes a motor circuit, a cabin heating circuit for heating a passenger cabin, a battery circuit for controlling the temperature of a battery circuit thermal load which includes at least one battery pack, a motor circuit temperature sensor, and a controller. The motor circuit is configured for cooling a motor circuit thermal load including the traction motor. The motor circuit thermal load has a motor circuit thermal load inlet and a motor circuit thermal load outlet. The motor circuit includes a radiator, a first motor circuit conduit fluidically between the radiator and the motor circuit thermal load inlet, a second motor circuit conduit fluidically between the radiator and the motor circuit thermal load outlet, and a motor circuit pump positioned to pump fluid through the motor circuit. The cabin heating circuit is configured for heat exchange with a cabin heating circuit thermal load which includes a cabin heater for heating the cabin. The cabin heating circuit thermal load has a cabin heating circuit thermal load inlet and a cabin heating circuit thermal load outlet, a first cabin heating circuit conduit fluidically between the motor circuit and the cabin heating circuit thermal load inlet, a second cabin heating circuit conduit fluidically between the cabin heating circuit thermal load outlet and the motor circuit, a third cabin heating circuit conduit fluidically between the second and first cabin heating circuit conduits, a cabin heating circuit heater positioned to heat fluid in the cabin heating circuit, a cabin heating circuit valve positionable in a first position wherein fluid flow between the motor circuit and the cabin heating circuit is substantially prevented and a second position wherein fluid flow between the motor circuit and the cabin heating circuit is permitted, and a cabin heating circuit pump positioned to pump fluid through the cabin heating circuit. The motor circuit temperature sensor is positioned to detect the temperature of fluid in the second motor circuit conduit. The battery circuit is configured for controlling the temperature of a battery circuit thermal load which includes the at least one battery pack. The battery circuit thermal load has a battery circuit thermal load inlet and a battery circuit thermal load outlet. The battery circuit includes a first battery circuit conduit fluidically between the motor circuit and the battery circuit thermal load inlet, a second battery circuit conduit fluidically between the battery circuit thermal load outlet and the motor circuit, a third battery circuit conduit fluidically between the second battery circuit conduit and the first battery circuit conduit, a battery circuit heater positioned to heat fluid in the battery circuit, a battery circuit valve positionable in a first position wherein fluid flow between the motor circuit and the battery circuit is substantially prevented and a second position wherein fluid flow between the motor circuit and the battery circuit is permitted, and a battery circuit pump positioned to pump fluid through the battery circuit. The controller is operatively connected to the cabin heating circuit valve to control the flow of fluid between the motor circuit and the cabin heating circuit and operatively connected to the battery circuit valve to control the flow of fluid between the motor circuit and the battery circuit, such that heat transferred to fluid in the motor circuit by the motor circuit thermal load is removed from the fluid by at least one of the group selected from the cabin heating circuit thermal load, the battery circuit thermal load and the radiator.

In a third aspect, the invention is directed to a thermal management system for an electric vehicle. The electric vehicle includes a traction motor and at least one battery pack. The thermal management system is capable of heating the at least one battery pack using a low voltage heater.

The thermal management system includes a battery circuit that is configured for controlling the temperature of a battery circuit thermal load including the at least one the battery pack, and including a battery circuit thermal load inlet and a battery circuit thermal load outlet. The battery circuit includes a first battery circuit conduit extending to the battery circuit thermal load inlet, a second battery circuit conduit from the battery circuit thermal load outlet, a third battery circuit conduit fluidically between the second battery circuit conduit and the first battery circuit conduit, and a battery circuit pump in the first battery circuit conduit configured to pump fluid through the battery circuit. The thermal management system includes a battery charge control module. When the vehicle is plugged into an electrical source the battery charge control module receives energy from the electrical source and processes the energy for storage in the at least one battery pack. When the at least one battery pack is below a selected battery pack temperature and the vehicle is plugged into an electrical source the controller is programmed to position the battery circuit valve in the second position wherein heat generated in the battery charge control module heats fluid passing through therethrough. The fluid is circulated to the at least one battery pack to heat the at least one battery pack. A battery circuit heater is positioned to heat fluid in the battery circuit. The battery circuit heater is configured to operate with an inlet voltage of 12VDC.

In a fourth aspect, the invention is directed to a thermal management system for an electric vehicle. The electric vehicle includes a traction motor and at least one battery pack. The thermal management system includes a motor circuit a battery circuit, a main cooling circuit, a motor circuit temperature sensor and a controller. The motor circuit is configured for cooling a motor circuit thermal load including the traction motor. The motor circuit thermal load has a motor circuit thermal load inlet and a motor circuit thermal load outlet. The motor circuit includes a radiator, a first motor circuit conduit fluidically between the radiator and the motor circuit thermal load inlet, a second motor circuit conduit fluidically between the radiator and the motor circuit thermal load outlet, and a motor circuit pump positioned to pump fluid through the motor circuit. The battery circuit is configured for controlling the temperature of a battery circuit thermal load which includes the at least one battery pack. The battery circuit thermal load has a battery circuit thermal load inlet and a battery circuit thermal load outlet. The battery circuit includes a first battery circuit conduit fluidically between the second motor circuit conduit upstream from the radiator and the battery circuit thermal load inlet, a second battery circuit conduit fluidically between the battery circuit thermal load outlet and the first motor circuit conduit, a third battery circuit conduit fluidically between the second battery circuit conduit and the first battery circuit conduit, a chiller positioned to cool fluid in the battery circuit, the chiller having a refrigerant inlet and a refrigerant outlet, a battery circuit valve positionable in a first position wherein fluid flow between the motor circuit and the battery circuit is substantially prevented and a second position wherein fluid flow between the motor circuit and the battery circuit is permitted, and a battery circuit pump positioned to pump fluid through the battery circuit. The main cooling circuit includes a compressor, a first cooling circuit conduit positioned upstream of the compressor and positioned for receiving refrigerant from the refrigerant outlet of the evaporator and for receiving refrigerant from the refrigerant outlet of the chiller, a condenser positioned downstream from the compressor, a second cooling circuit conduit positioned downstream of the condenser and positioned for delivering refrigerant to the refrigerant inlet of the chiller and to the refrigerant inlet of the evaporator and a chiller refrigerant flow control valve positioned for controlling the flow of refrigerant through the chiller. The motor circuit temperature sensor is positioned to detect the temperature of fluid in the second motor circuit conduit. The controller is operatively connected to the chiller refrigerant flow control valve, the evaporator refrigerant flow control valve, the battery circuit valve, the battery circuit pump and the compressor. The controller is programmed to open the chiller refrigerant flow control valve based on a comparison of the temperature sensed by the motor circuit temperature sensor and a target temperature for the battery circuit thermal load, and to open the evaporator refrigerant flow control valve based on a temperature setting of a climate control system for the passenger cabin.

### BRIEF DESCRIPTION OF THE DRAWINGS

The present invention will now be described, by way of example only, with reference to the attached drawings, in which:

FIG. 1 is a perspective view of an electric vehicle that includes a thermal management system in accordance with an embodiment of the present invention;

FIG. 2 is a schematic illustration of a thermal management system for the electric vehicle; and

FIG. 3 is a graph of the temperature of battery packs that are part of the electric vehicle shown in FIG. 1.

### DETAILED DESCRIPTION OF THE INVENTION

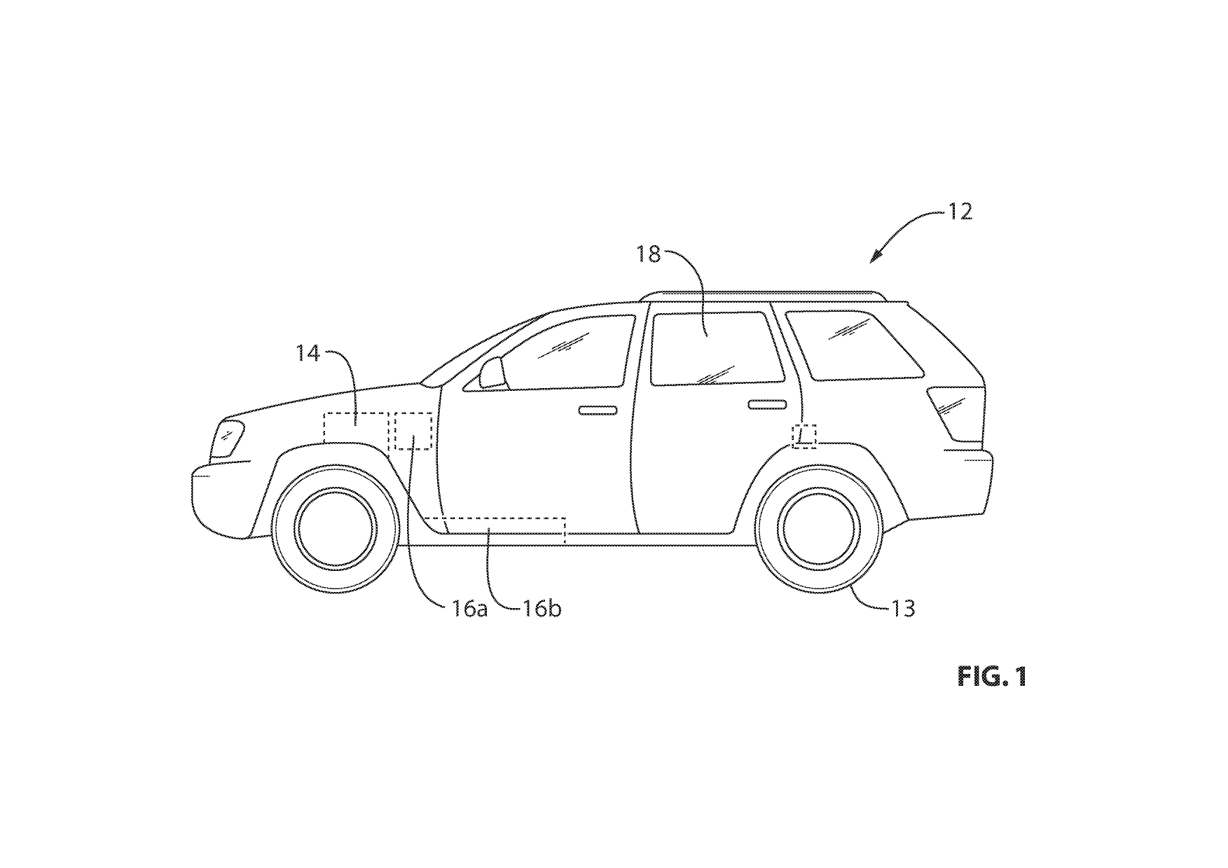

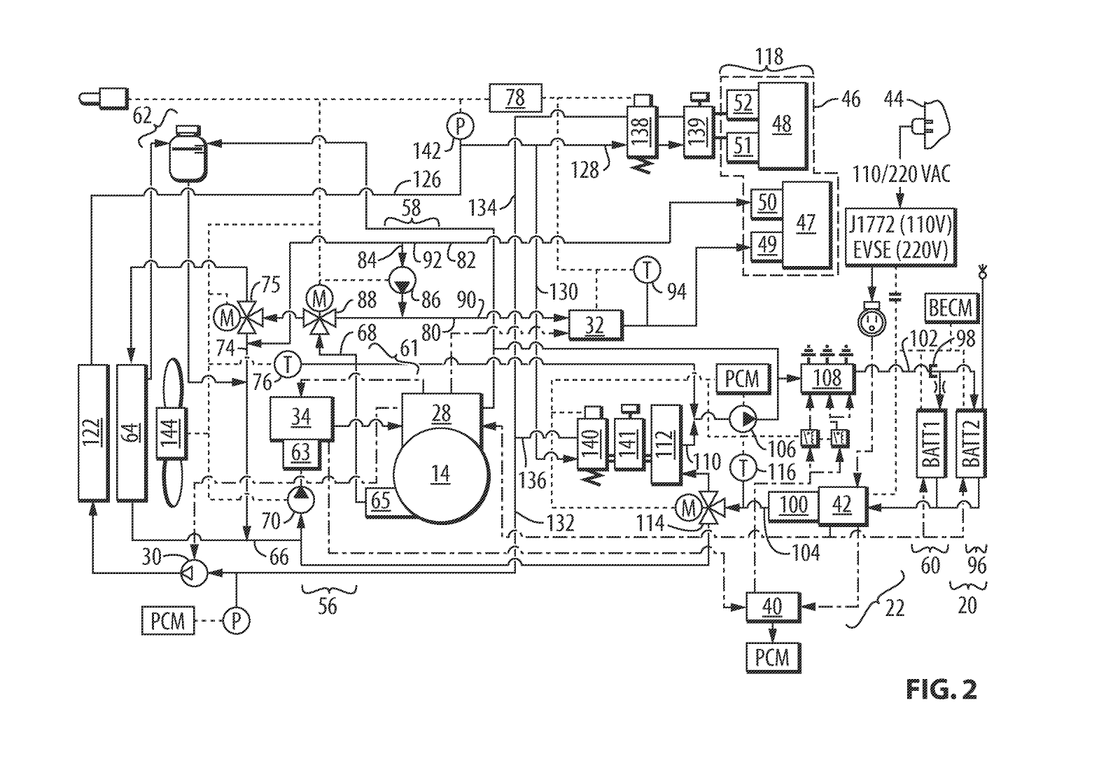

Reference is made to FIG. 2, which shows a schematic illustration of a thermal management system 10 for an electric vehicle 12 shown in FIG. 1. The electric vehicle 12 includes wheels 13, a traction motor 14 for driving the wheels 13, first and second battery packs 16a and 16b, a cabin 18, a high voltage electrical system 20 (FIG. 2) and a low voltage electrical system 22 (FIG. 2).

The motor 14 may have any suitable configuration for use in powering the electric vehicle 12. The motor 14 may be mounted in a motor compartment that is forward of the cabin 18 and that is generally in the same place an engine compartment is on a typical internal combustion powered vehicle. Referring to FIG. 2, the motor 14 generates heat during use and thus requires cooling. To this end, the motor 14 includes a motor coolant flow conduit for transporting coolant fluid about the motor 14 so as to maintain the motor within a suitable temperature range.

A transmission control system shown at 28 is part of the high voltage electrical system 20 and is provided for controlling the current flow to high voltage electrical loads within the vehicle 12, such as the motor 14, an air conditioning compressor 30, a heater 32 and a DC/DC converter 34. The transmission control system 28 generates heat during use and thus has a transmission control system coolant flow conduit associated therewith, for transporting coolant fluid about the transmission control system 28 so as to maintain the transmission control system 28 within a suitable temperature range. The transmission control system 28 may be positioned immediately upstream fluidically from the motor 14.

The DC/DC converter 34 receives current from the transmission control system 28 and converts it from high voltage to low voltage. The DC/DC converter 34 sends the low voltage current to a low voltage battery shown at 40, which is used to power low voltage loads in the vehicle 12. The low voltage battery 40 may operate on any suitable voltage, such as 12 V.

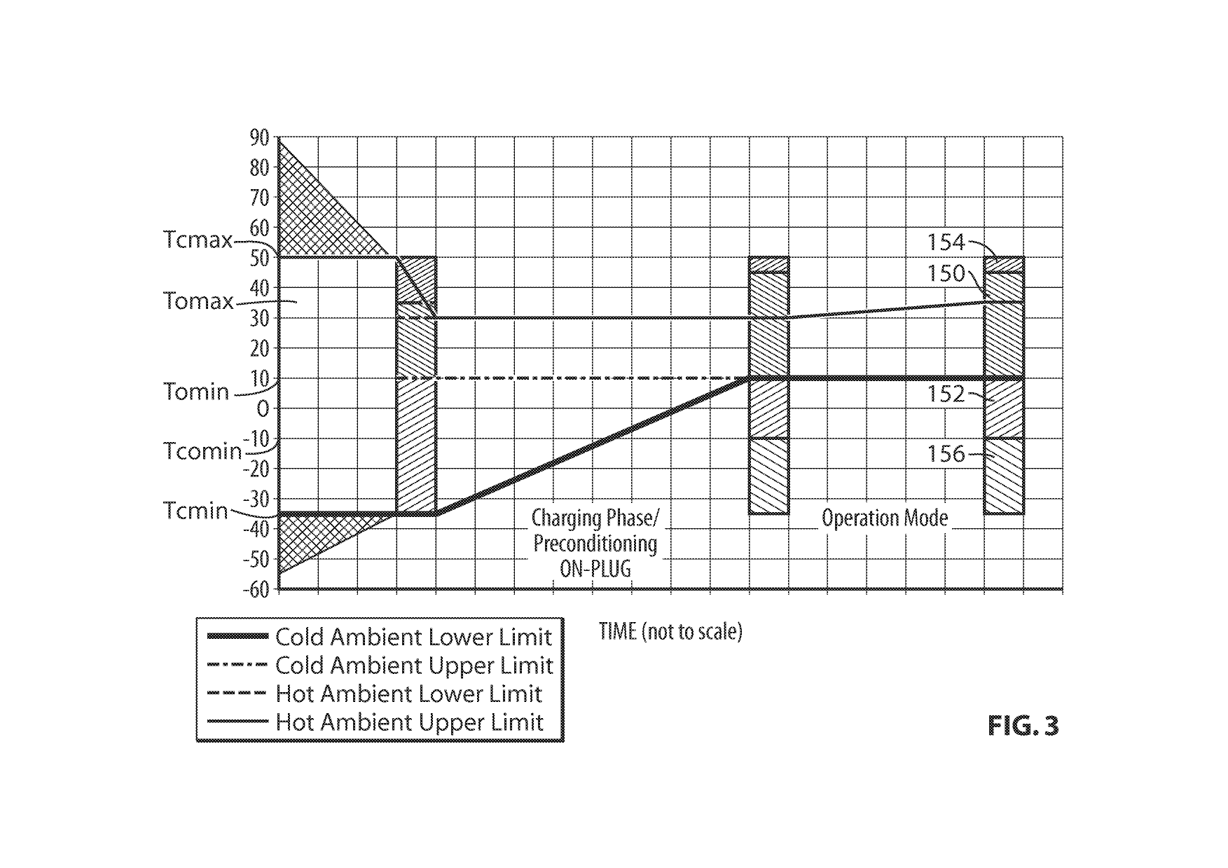

The battery packs 16a and 16b send power to the transmission control system 28 for use by the motor 14 and other high voltage loads and thus form part of the high voltage electrical system 20. The battery packs 16a and 16b may be any suitable types of battery packs. In an embodiment, the battery packs 16a and 16b are each made up of a plurality of lithium polymer cells. The battery packs 16a and 16b have a temperature range (shown in FIG. 3) in which they are preferably maintained so as to provide them with a relatively long operating life. While two battery packs 16a and 16b are shown, it is alternatively possible to have any suitable number of battery packs, such as one battery pack, or 3 or more battery packs depending on the packaging constraints of the vehicle 12.

A battery charge control module shown at 42 is provided and is configured to connect the vehicle 12 to an electrical source (such as, for example, a 110V source, or a 220V source) shown at 44, and to send the current received from the electrical source 44 to any of several destinations, such as, the battery packs 16a and 16b, the transmission control system 28 and the low voltage battery 40. The battery charge control module 42 generates heat during use and thus requires cooling. To this end, the battery charge control module 42 includes a battery charge control module fluid flow conduit for transporting fluid about the battery charge control module 42 from a battery charge control module inlet 4 to a battery charge control module outlet 26 so as to maintain the battery charge control module 42 within a suitable temperature range.

An HVAC system 46 is provided for controlling the temperature of the cabin 18 (FIG. 1). The HVAC system 46 is configured to be capable of both cooling and heating the cabin 18. To achieve this, the HVAC system 46 may include one or more heat exchangers, such as a cabin heating heat exchanger 47 and a cabin cooling heat exchanger 48 (which may be referred to as evaporator 48). The cabin heating heat exchanger 47 has a heat exchange fluid inlet 49 and a heat exchange fluid outlet 50 and is used to heat an air flow that is passed into the cabin 18. The cabin cooling heat exchanger 48 includes a refrigerant inlet 51 and a refrigerant outlet 52, and is used to cool an air flow that is passed into the cabin 18.

The motor 14, the transmission control system 28, the DC/DC converter 34, the battery packs 16a and 16b, the battery charge control module 42 and the HVAC system 46 constitute thermal loads on the thermal management system 10.

The thermal management system 10 includes a motor circuit 56, a cabin heating circuit 58, a battery circuit 60 and a main cooling circuit 62. The motor circuit 56 is configured for cooling the traction motor 14, the transmission control system 28 and the DC/DC converter 34, which constitute a motor circuit thermal load 61, which has a motor circuit thermal load inlet 63 and a motor circuit thermal load outlet 65. The motor circuit 56 includes a radiator 64, a first motor circuit conduit 66 fluidically between the radiator 64 to the motor circuit thermal load inlet 63, a second motor circuit conduit 68 fluidically between the motor circuit thermal load outlet 65 and the radiator 64, and a motor circuit pump 70 positioned to pump heat exchange fluid through the motor circuit 56.

Additionally a third motor circuit conduit 74 may be provided fluidically between the second and first motor circuit conduits 68 and 66 so as to permit the flow of heat exchange fluid to bypass the radiator 64 when possible (for example, when the heat exchange fluid is below a selected threshold temperature). To control whether the flow of heat exchange fluid is directed through the radiator 64 or through the third motor circuit conduit 74, a radiator bypass valve 75 is provided and may be positioned in the second motor circuit conduit 68. The radiator bypass valve 75 is controllable so that in a first position it directs the flow of heat exchange fluid to the radiator 64 through the second motor circuit conduit 68 and in a second position it directs the flow of heat exchange fluid to the first motor circuit conduit 66 through the third motor circuit conduit 74, so as to bypass the radiator 64. Flow through the third motor circuit conduit 74 is easier than flow through the radiator 64 (in other words, there is less of a pressure drop associated with flow through the third conduit than there is with flow through the radiator 64) and so bypassing the radiator 64 whenever possible, reduces the energy consumption of the pump 70. By reducing the energy consumed by components in the vehicle 12 (FIG. 1), the range of the vehicle can be extended, which is particularly advantageous in electric vehicles.

It will be noted that only a single radiator bypass valve 75 is provided for bypassing the radiator 64. When the radiator bypass valve 75 is in the first position, all of the heat exchange fluid flow is directed through the second conduit 68, through the radiator 64 and through the first conduit 66. There is no net flow through the third conduit 74 because there is no net flow into the third conduit. Conversely, when the radiator bypass valve 75 is in the second position, all of the heat exchange fluid flow is directed through the third conduit 74 and back to the first conduit 66. There is no net flow through the radiator 64 because there is no net flow into the radiator 64. Thus, using only a single valve (such as the bypass valve 75) provides the capability of selectably bypassing the radiator 64, instead of using one valve at the junction of the second and third conduits 68 and 74 and another valve at the junction of the first and third conduits 66 and 74. As a result of using one valve (such as valve 75) instead of two valves, the motor circuit 56 contains fewer components, thereby making it less expensive, simpler to make and to operate and more reliable. Furthermore by eliminating one valve, the energy required to move the heat exchange fluid through the motor circuit 56 is reduced, thereby reducing the energy consumed by the pump 70 and extending the range of the vehicle 12 (FIG. 1).

The pump 70 may be positioned anywhere suitable, such as in the first motor circuit conduit 66.

The elements that make up the motor circuit thermal load may be arranged in any suitable way. For example, the DC/DC converter 34 may be downstream from the pump 70 and upstream from the transmission control system 28, and the motor 14 may be downstream from the transmission control system 28. Thus, the inlet to the DC/DC converter 34 constitutes the thermal load inlet 63 and the motor outlet constitutes the thermal load outlet 65.

A motor circuit temperature sensor 76 is provided for determining the temperature of heat exchange fluid at a selected point in the motor circuit 56. As an example, the motor circuit temperature sensor 76 may be positioned downstream from all the thermal loads in the motor circuit 56, so as to record the highest temperature of the heat exchange fluid. Based on this temperature, a controller, shown at 78, can determine whether or not to position the radiator bypass valve 75 in a first position wherein the radiator bypass valve 75 transfers the flow of heat exchange fluid towards the radiator 64 and a second position wherein the radiator bypass valve 75 bypasses the radiator 64 and transfers the flow of heat exchange fluid through the third motor circuit conduit 74 back to the first motor circuit conduit 66.

The cabin heating circuit 58 is configured for providing heated heat exchange fluid to the HVAC system 46 and more specifically to the cabin heating heat exchanger 47, which constitutes the cabin heating circuit thermal load. The cabin heating circuit 58 includes a first cabin heating circuit conduit 80 fluidically between the second motor circuit conduit 68 and the cabin heating heat exchanger inlet 49 (which in the embodiment shown is the inlet to the cabin heating circuit thermal load), a second cabin heating circuit conduit 82 fluidically between the cabin heating circuit heat exchanger outlet 50 (which in the embodiment shown is the outlet from the cabin heating circuit thermal load) to the motor circuit 56. In the embodiment shown the second cabin heating circuit conduit 82 extends to the third motor circuit conduit 74. This is because the cabin heating heat exchanger 47 serves to cool the heat exchange fluid by some amount, so that the resulting cooled heat exchange fluid need not be passed through the radiator 64 in the motor circuit 56. By reducing the volume of heat exchange fluid that passes through the radiator 64, energy consumed by the pump 70 is reduced, thereby extending the range of the vehicle 12 (FIG. 1). It will be understood that in an alternative, less-preferred embodiment however, the second cabin heating circuit conduit 82 may extend to the second motor circuit conduit 68 downstream so that the heat exchange fluid contained in the second cabin heating circuit conduit 82 passes through the radiator 64.

In some situations the heat exchange fluid will not be sufficiently hot to meet the demands of the HVAC system 46. For such situations, the heater 32 which may be referred to as the cabin heating circuit heater 32 is provided in the first cabin heating circuit conduit 80. The cabin heating circuit heater 32 may be any suitable type of heater, such as an electric heater that is one of the high voltage electrical components fed by the transmission control system 28.

A third cabin heating circuit conduit 84 may be provided between the second and first cabin heating circuit conduits 82 and 80. A cabin heating circuit pump 86 is provided in the third conduit 84. In some situations it will be desirable to circulate heat exchange fluid through the cabin heating circuit 58 and not to transfer the fluid back to the motor circuit 56. For example, when the fluid is being heated by the heater 32 it may be advantageous to not transfer the fluid back to the motor circuit 56 since the fluid in the motor circuit 56 is used solely for cooling the thermal load 61 and it is thus undesirable to introduce hot fluid into such a circuit. For the purpose of preventing fluid from being transferred from the cabin heating circuit 58 back to the motor circuit 56, a cabin heating circuit valve 88 is provided. In the embodiment shown, the cabin heating circuit valve 88 is positioned in the second motor circuit conduit 68 and is positionable in a first position wherein the valve 88 directs fluid flow towards the radiator 64 through the second motor circuit conduit 68, and a second position wherein the valve 88 directs fluid flow towards the cabin heater heat exchanger 47 through the first cabin heating circuit conduit 80.

When the cabin heating circuit valve 88 is in the second position, the pump 86 may operate at a selected, low, flow rate to prevent the fluid flow from short circuiting the cabin heating circuit by flowing up the third conduit 84.

It will be noted that separation of the fluid flow through the cabin heating circuit 58 and the motor circuit 56 is achieved using a single valve (such as valve 88) which is positioned at the junction of the second motor circuit conduit 68 and the first cabin heating circuit conduit 80. When the valve 88 is positioned in the first position, fluid is directed towards the radiator 64. There is no net flow out of the cabin heating circuit 58 since there is no flow into the cabin heating circuit 58. When the valve 88 is positioned in the second position and the pump 86 is off; fluid is directed through the cabin heating circuit 58 and back into the motor circuit 56. When the valve 88 is positioned in the first position and the pump 86 is on, there is no net flow out of the second cabin heating circuit conduit 82 as noted above, however, the pump 86 generates a fluid circuit loop and drives fluid in a downstream portion 90 of the first cabin heating circuit conduit 80, through the cabin heating heat exchanger 47, and through an upstream portion 92 of the second cabin heating circuit conduit 82, whereupon the fluid is drawn back into the pump 86. Because this feature is provided using a single valve (such as valve 88), as opposed to using one valve at the junction of the first cabin heating circuit conduit 80 and the motor circuit 56 and another valve at the junction of the second cabin heating circuit conduit 82 and the motor circuit 56, the thermal management system 10 is made simpler and less expensive, and it further saves energy consumption by having fewer valves in the system 10 so as to reduce the energy required by the pump 70 to pump liquid through such valves.

Additionally, the valve 88 combined with the pump 86 permit isolating heated fluid in the cabin heating circuit 58 from the fluid in the motor circuit 56, thereby preventing fluid that has been heated in the cabin heating circuit heater 32 from being sent to the radiator 64 to be cooled.

A cabin heating circuit temperature sensor 94 may be provided for determining the temperature of the fluid in the cabin heating circuit 58. The temperature sensor 94 may be positioned anywhere suitable, such as downstream from the cabin heating circuit heater 32. The temperature sensor 94 may communicate with the controller 78 so that the controller 78 can determine whether or not to carry out certain actions. For example, using the temperature sensed by the temperature sensor 94, the controller 78 can determine whether the heater 32 should be activated to meet the cabin heating demands of the HVAC system 46.

The battery circuit 60 is configured for controlling the temperature of the battery packs 16a and 16b and the battery charge control module 42, which together make up the battery circuit thermal load 96. A thermal load inlet is shown at 98 upstream from the battery packs 16a and 16b and a thermal load outlet is shown at 100 downstream from the battery charge control module 42. The battery packs 16a and 16b are in parallel in the battery circuit 60, which permits the fluid flow to each of the battery packs 16a and 16b to be selected individually so that each battery pack 16a or 16b receives as much fluid as necessary to achieve a selected temperature change. It may be possible to provide a means for adjusting the flow of fluid that goes to each battery pack 16a and 16b during use of the thermal management system 10, so that the fluid flow can be adjusted to meet the instantaneous demands of the battery packs 16a and 16b. After the fluid has passed through the battery packs 16a and 16b, the fluid is brought into a single conduit which passes through the battery charge control module 42. While the battery packs 16a and 16b are shown in parallel in the battery circuit 60, they could be provided in series in an alternative embodiment.

A first battery circuit conduit 102 extends between the second motor circuit conduit 68 and the battery circuit thermal load inlet 98. A second battery circuit conduit 104 extends between the thermal load outlet 100 and the first motor circuit conduit 66. A battery circuit pump 106 may be provided for pumping fluid through the battery circuit 60 in situations where the battery circuit 60 is isolated from the motor circuit 56. A battery circuit heater 108 is provided in the first conduit 102 for heating fluid upstream from the thermal load 96 in situations where the thermal load 96 requires it. The battery circuit heater 108 may operate on current from a low voltage current source, such as the low voltage battery 40. This is discussed in further detail further below.

A third battery circuit conduit 110 may be provided fluidically between the second and first battery circuit conduits 102 and 104 so as to permit the flow of heat exchange fluid in the battery circuit 60 to be isolated from the flow of heat exchange fluid in the motor circuit 56. A chiller 112 may be provided in the third conduit 110 for cooling fluid upstream from the thermal load 96 when needed.

A battery circuit valve 114 is provided in the second conduit 104 and is positionable in a first position wherein the flow of fluid is directed towards the first motor circuit conduit 66 and in a second position wherein the flow of fluid is directed into the third battery circuit conduit 114 towards the first battery circuit conduit 102.

It will be noted that the flow in the battery circuit 60 is isolated from the flow in the motor circuit 56 with only one valve (such as valve 114). When the valve 114 is in the second position so as to direct fluid flow through the third conduit 110 into the first conduit 102, there is effectively no flow from the first motor circuit 56 through the first conduit 102 since the loop made up of the downstream portion of the first conduit 102, the thermal load 96, the second conduit 104 and the third conduit 110 is already full of fluid. By using only one valve (such as valve 114) to isolate the battery circuit 60, the amount of energy consumed by the pump 106 to pump fluid around the battery circuit 60 is reduced relative to a similar arrangement using two valves. Additionally, by using only one valve the battery circuit is simpler (i.e., it has fewer components), which reduces its cost and which could increase its reliability.

A battery circuit temperature sensor 116 is provided for sensing the temperature of the fluid in the battery circuit 60. The temperature sensor 116 may be positioned anywhere in the battery circuit 60, such as in the second conduit 104 downstream from the thermal load 96. The temperature from the temperature sensor 116 can be sent to the controller 78 to determine whether to have the valve 114 should be in the first or second position and whether any devices (such as, for example, the chiller 112, the heater 108) need to be operated to adjust the temperature of the fluid in the first conduit 102.

The main cooling circuit 62 is provided for assisting in the thermal management of the thermal loads in the HVAC system 46 and the battery circuit 60. More particularly, the thermal load in the HVAC system 46 is shown at 118 and is made up of the cabin cooling heat exchanger 48 (i.e., the evaporator 48).

The components of the main cooling circuit 62 that are involved in the cooling and management of the refrigerant flowing therein include the compressor 30 and a condenser 122. A first cooling circuit conduit 126 extends from the condenser 122 to a point wherein the conduit 126 divides into a first branch 128 which leads to the HVAC system 46 and a second branch 130 which leads to the battery circuit 60. A second cooling circuit conduit 132 has a first branch 134 that extends from the HVAC system 46 to a joining point and a second branch 136 that extends from the battery circuit 60 to the joining point. From the joining point, the second cooling circuit conduit 132 extends to the inlet to the compressor 30.

At the downstream end of the first branch 128 of the first conduit 126 is a flow control valve 138 which controls the flow of refrigerant into the cabin cooling heat exchanger 48. The upstream end of the first branch 134 of the second conduit 132 is connected to the refrigerant outlet from the heat exchanger 48. It will be understood that the valve 138 could be positioned at the upstream end of the first branch 134 of the second conduit 132 instead. The valve 138 is controlled by the controller 78 and is opened when refrigerant flow is needed through the heat exchanger 48.

At the downstream end of the second branch 130 of the first conduit 126 is a flow control valve 140 which controls the flow of refrigerant into the battery circuit chiller 112. The upstream end of the second branch 136 of the second conduit 132 is connected to the refrigerant outlet from the chiller 112. It will be understood that the valve 140 could be positioned at the upstream end of the second branch 136 of the second conduit 132 instead. The valve 140 is controlled by the controller 78 and is opened when refrigerant flow is needed through the chiller 112.

The valves 138 and 140 may be any suitable type of valves with any suitable type of actuator. For example, they may be solenoid actuated/spring return valves. Additionally thermostatic expansion valves shown at 139 and 141 may be provided downstream from the valves 138 and 140.

A refrigerant pressure sensor 142 may be provided anywhere suitable in the cooling circuit 62, such as on the first conduit 126 upstream from where it divides into the first and second branches 128 and 130. The pressure sensor 142 communicates pressure information from the cooling circuit 62 to the controller 78.

A fan shown at 144 is provided for blowing air on the radiator 64 and the condenser 122 to assist in cooling and condensing the heat exchange fluid and the refrigerant respectively. The fan 144 is controlled by the controller 78.

An expansion tank 124 is provided for removing gas that can accumulate in other components such as the radiator 64. The expansion tank 124 is preferably positioned at the highest elevation of any fluid-carrying components of the thermal management system. The expansion tank 124 may be used as a point of entry for heat exchange fluid into the thermal management system 10 (i.e., the system 10 may be filled with the fluid via the expansion tank 124).

The controller 78 is described functionally as a single unit, however the controller 78 may be made up of a plurality of units that communicate with each other and which each control one or more components of the thermal management system 10, as well as other components optionally.

The logic used by the controller 78 to control the operation of the thermal management system 10 depends on which of several states the vehicle is in. The vehicle may be on-plug and off, which means that the vehicle itself is off (for example, the ignition key is out of its slot in the instrument panel) and is plugged into an external electrical source (for example, for recharging the battery packs 16a and 16b). The vehicle may be off-plug and off, which means that the vehicle itself is off and is not plugged into an external electrical source. The vehicle may be off-plug and on, which means that the vehicle itself is on and is not plugged into an external electrical source. The logic used by the controller 78 may be as follows:

The controller 78 attends to the cooling requirements of the thermal load 61 of the motor circuit 56 when the vehicle is off-plug and when the vehicle is on. The controller 78 determines a maximum permissible temperature for the heat exchange fluid and determines if the actual temperature of the heat exchange fluid exceeds it (based on the temperature sensed by the temperature sensor 76) by more than a selected amount (which is a calibrated value, and which could be zero for example). If so, the controller operates the pump 70 to circulate the heat exchange fluid through the motor circuit 56. Initially when the vehicle enters the state of being off-plug and on, the controller 78 may default to a ‘cooling off’ mode wherein the pump 70 is not turned on, until it has determined and compared the aforementioned temperature values. In the event that the vehicle is in a fault state, the controller 78 may enter a motor circuit cooling fault mode. When the controller 78 exits the fault state, the controller 78 may pass to the ‘cooling off’ mode.

The controller 78 attends to the heating and cooling requirements of the cabin heating circuit 58 when the vehicle is on-plug and when the vehicle is off-plug and on. The controller 78 may have three cabin heating modes. The controller 78 determines if the requested cabin temperature from the climate control system in the cabin 18 exceeds the temperature sensed by a temperature sensor in the evaporator 48 that senses the actual temperature in the cabin 18 by a selected calibrated amount. If so, and if the vehicle is either off plug and on or on plug and there is sufficient power available from the electrical source, and if the controller 78 determines if the temperature sensed by the temperature sensor 76 is higher than the requested cabin temperature by a selected calibrated amount. If it is higher, then the controller 78 positions the cabin heating circuit valve 88 in its second position wherein flow is generated through the cabin heating circuit 58 from the motor circuit 56 and the controller 78 puts the cabin heating circuit heater 32 in the off position. These settings make up the first cabin heating mode. If the temperature sensed by the temperature sensor 76 is lower than the requested cabin temperature by a selected calibrated amount, then the controller 78 positions the cabin heating circuit valve 88 in the first position and turns on the pump 86 so that flow in the cabin heating circuit 58 is isolated from flow in the motor circuit 56, and the controller 78 additionally turns on the cabin heating circuit heater 32 to heat the flow in the cabin heating circuit 58. These settings make up the second cabin heating mode.

If the temperature sensed by the temperature sensor 76 is within a selected range of the requested temperature from the climate control system then the controller 78 positions the cabin heating circuit valve 88 in the second position so that flow in the cabin heating circuit 58 is not isolated from flow in the motor circuit 56, and the controller turns the heater 32 on. These settings make up the third cabin heating mode. The selected range may be the requested temperature from the climate control system minus the selected calibrated value, to the requested temperature from the climate control system plus the selected calibrated value.

The default state for the controller 78 when cabin heating is initially requested may be to use the first cabin heating mode.

The controller 78 may have one cabin cooling mode. The controller 78 determines if the actual temperature of the evaporator 48 is lower than the target temperature of the evaporator 48 by more than a calibrated amount. If so, and if the vehicle is either off plug and on or on plug and there is sufficient power available from the electrical source, then the controller 78 turns on the compressor 30 and moves the refrigerant flow control valve 138 to the open position so that refrigerant flows through the cabin cooling heat exchanger 48 to cool an air flow that is passed into the cabin 18.

The thermal management system 10 will enter a cabin heating and cabin cooling fault mode when the vehicle is in a fault state.

When the climate control system in the cabin 18 is set to a ‘defrost’ setting, the controller 78 will enter a defrost mode, and will return to whichever heating or cooling mode it was in once defrost is no longer needed.

The default mode for the controller 78 with respect to the cabin heating circuit 58 may be to have the cabin heating circuit valve 88 in the first position to direct flow towards the radiator, and to have the heater 32 off, the pump 86 off. The default mode for the controller 78 with respect to cooling the cabin 18 may to be to have the refrigerant flow control valve 138 in the closed position to prevent refrigerant flow through the cabin cooling heat exchanger 48, and to have the compressor 30 off.

The controller 78 attends to the heating and cooling requirements of the battery circuit 60 when the vehicle is on-plug and is off, and when the vehicle is off-plug and is on. The controller 78 may have three cooling modes for cooling the battery circuit thermal load 96. The controller 78 determines a desired battery pack temperature based on the particular situation, and determines if a first cooling condition is met, which is whether the desired battery pack temperature is lower than the actual battery pack temperature by a first selected calibrated amount. If the first cooling condition is met, the controller 78 determines which of the three cooling modes it will operate in by determining which, if any, of the following second and third cooling conditions are met. The second condition is whether the temperature sensed by the temperature sensor 76 is lower than the desired battery pack temperature by a second selected calibrated amount, which may, for example, be related to the expected temperature rise that would be incurred in the flow of fluid from the temperature sensor 76 to the battery circuit thermal load 96. If the second condition is met, then the controller 78 operates in a first battery circuit cooling mode, wherein it positions the battery circuit valve 114 in its second position wherein flow is generated through the battery circuit 60 from the motor circuit 56 and the controller 78 puts the refrigerant flow control valve 140 in the closed position preventing refrigerant flow through the chiller 112.

The third cooling condition is whether the temperature sensed by the temperature sensor 76 is greater than the desired battery pack temperature by at least a third selected calibrated amount, which may, for example, be related to the expected temperature drop associated with the chiller 112. If the third cooling condition is met, then the controller 78 operates in a second battery circuit cooling mode wherein it positions the battery circuit valve 114 in the first position and turns on the pump 106 so that flow in the battery circuit 60 is isolated from flow in the motor circuit 56, and the controller 78 additionally positions the flow control valve 140 in the open position so that refrigerant flows through the chiller 112 to cool the flow in the battery circuit 60.

If neither the second or third cooling conditions are met (i.e., if the temperature sensed by the temperature sensor 76 is greater than or equal to the desired battery pack temperature minus the second selected calibrated amount and the temperature sensed by the temperature sensor 76 is less than or equal to the desired battery pack temperature plus the third selected calibrated amount), then the controller 78 operates in a third battery circuit cooling mode wherein it positions the battery circuit valve 114 in the second position so that flow in the battery circuit 60 is not isolated from flow in the motor circuit 56, and the controller 78 turns the chiller 112 on.

It will be understood that in any of the battery circuit cooling modes, the controller 78 turns the battery circuit heater 108 off.

The default state for the controller 78 when battery circuit thermal load cooling is initially requested may be to use the first battery circuit cooling mode.

The controller 78 may have three battery circuit heating modes. The controller 78 determines a desired battery circuit thermal load temperature based on the particular situation, and determines whether a first heating condition is met, which is whether the desired battery pack temperature is higher than the actual battery pack temperature by a first selected calibrated amount. If the first heating condition is met, the controller 78 determines which of the three heating modes it will operate in by determining which, if any, of the following second and third heating conditions are met. The second heating condition is whether the temperature sensed by the temperature sensor 76 is higher than the desired battery pack temperature by a second selected calibrated amount that may, for example, be related to the expected temperature drop of the fluid as it flows from the temperature sensor 76 to the battery circuit thermal load 96. If the second condition is met, then the controller 78 operates in a first battery circuit heating mode, wherein it positions the battery circuit valve 114 in its second position wherein flow is generated through the battery circuit 60 from the motor circuit 56 and the controller 78 turns the battery circuit heater 32 off.

The third heating condition is whether the temperature sensed by the temperature sensor 76 is lower than the desired battery pack temperature by at least a third selected calibrated amount, which may, for example, be related to the expected temperature rise associated with the battery circuit heater 108. If this third heating condition is met, then the controller 78 operates in a second battery circuit heating mode wherein it positions the battery circuit valve 114 in the first position and turns on the pump 106 so that flow in the battery circuit 60 is isolated from flow in the motor circuit 56, and the controller 78 additionally turns on the battery circuit heater 108 to heat the flow in the battery circuit 60.

If neither the second or third conditions are met (i.e., if the temperature sensed by the temperature sensor 76 is less than or equal to the desired battery pack temperature plus the second selected calibrated amount and the temperature sensed by the temperature sensor 76 is greater than or equal to the desired battery pack temperature minus the third selected calibrated amount), then the controller 78 operates in a third battery circuit heating mode wherein it positions the battery circuit valve 114 in the second position so that flow in the battery circuit 60 is not isolated from flow in the motor circuit 56, and the controller 78 turns the battery circuit heater 108 on.

The default state for the controller 78 when battery circuit thermal load heating is initially requested may be to use the first battery circuit heating mode.

The thermal management system 10 will enter a battery circuit heating and cooling fault mode when the vehicle is in a fault state.

When the vehicle is off-plug, the controller 78 heats the battery circuit thermal load 96 using only the first battery circuit heating mode.

The default state for the controller 78 when the vehicle is turned on is to position the battery circuit valve 114 in the first position so as to not generate fluid flow through the battery circuit 60.

The controller 78 may operate using several other rules in addition to the above. For example the controller 78 may position the radiator bypass valve 75 in the first position to direct fluid flow through the radiator 64 if the temperature of the fluid sensed at sensor 76 is greater than the maximum acceptable temperature for the fluid plus a selected calibrated value and the cabin heating circuit valve 88 is in the first position and the battery circuit valve 114 is in the first position.

The controller 78 may also position the radiator bypass valve 75 in the first position to direct fluid flow through the radiator 64 if the temperature of the fluid sensed at sensor 76 has risen to be close to the maximum acceptable temperature for the fluid plus a selected calibrated value and the cabin heating circuit valve 88 is in the second position and the battery circuit valve 114 is in the second position.

In the event of an emergency battery shutdown, the controller 78 will shut off the compressor 30 and will turn on the cabin heating circuit heater 32 so as to bleed any residual voltage.

The temperature of the battery packs 16a and 16b may be maintained above their minimum required temperatures by the controller 78 through control of the refrigerant flow control valve 140 to the chiller 112. The temperature of the evaporator may be maintained above a selected temperature which is a target temperature minus a calibrated value, through opening and closing of the refrigerant flow control valve 138. The speed of the compressor 30 will be adjusted based on the state of the flow control valve 140 and of the flow control valve 138.

The controller 78 is programmed with the following high level objectives and strategies using the above described modes. The high level objectives include:

A. control the components related to heating and cooling of the battery circuit thermal load 96 to maintain the battery packs 16a and 16b and the battery charge control module 42 within the optimum temperature range during charging and vehicle operation;

B, maintain the motor 14, the transmission control system 28 and the DC/DC converter 34 at their optimum temperature ranges;

C. control the components related to heating and cooling the cabin 18 based on input from the climate control system; and

D. operate with a goal of maximizing vehicle range while meeting vehicle system requirements.

The controller 78 uses the following high level strategy on-plug:

When the vehicle is on-plug and is off, the controller 78 pre-conditions the battery packs 16a and 16b if required. Pre-conditioning entails bringing the battery packs 16a and 16b into a temperature range wherein the battery packs 16a and 16b are able to charge more quickly.

The controller 78 determines the amount of power available from the electrical source for temperature control of the battery packs 16a and 16b, which is used to determine the maximum permitted compressor speed, maximum fan speed or the battery pack heating requirements depending on whether the battery packs 16a and 16b require cooling or heating. A calibratible hysteresis band will enable the battery pack temperature control to occur in a cyclic manner if the battery pack temperatures go outside of the selected limits (which are shown in FIG. 3). If sufficient power is available from the electrical source, the battery packs 16a and 16b may be charged while simultaneously being conditioned (i.e., while simultaneously being cooled or heated to remain within their selected temperature range). If the battery packs 16a and 16b reach their fully charged state, battery pack conditioning may continue, so as to bring the battery packs 16a and 16b to their selected temperature range for efficient operation.

When the vehicle is on-plug the battery circuit heater 108 may be used to bring the battery packs 16a and 16b up to a selected temperature range, as noted above. In one of the heating modes described above for the battery circuit 60, the battery circuit valve 114 is in the second position so that the flow in the battery circuit 60 is isolated from the flow in the motor circuit 56, and therefore the battery circuit heater 108 only has to heat the fluid in the battery circuit 60.

The cabin may be pre-conditioned (such as, for example, heated or cooled while the vehicle is off) when the vehicle is on-plug and the state of charge of the battery packs 16a and 16b is greater than a selected value.

If the vehicle is started while on-plug, the controller 78 may continue to condition the battery packs 16a and 16b, to cool the motor circuit thermal load 61 and use of the HVAC system 46 for both heating and cooling the cabin 18 may be carried out.

When the vehicle is off-plug, battery pack heating may be achieved solely by using the heat in the fluid from the motor circuit (i.e., without the need to activate the battery circuit heater 108). Thus, while the vehicle is off-plug and on and the battery packs 16a and 16b require heating, the battery circuit valve 114 may be in the first position so that the battery circuit 60 is not isolated from the motor circuit 56. Some flow may pass through the third battery circuit conduit 110 for flow balancing purposes, however the refrigerant flow to the chiller 112 is prevented while the battery packs 16a and 16b require heating. By using low-voltage battery circuit heaters instead of high-voltage heaters for the heaters 108, a weight-savings is achieved which thereby extends the range of the vehicle.

When the vehicle is off-plug, battery pack cooling may be achieved by isolating the battery circuit 60 from the motor circuit 56 by moving the battery circuit valve 114 to the second position and by opening the flow of refrigerant to the chiller 112 by moving the flow control valve 140 to its open position, and by running the compressor 30, as described above in one of the three cooling modes for the battery circuit 60.

It will be noted that the battery packs 16a and 16b may sometimes reach different temperatures during charging or vehicle operation. The controller 78 may at certain times request isolation of the battery circuit 60 from the motor circuit 56 and may operate the battery circuit pump 106 without operating the heater 108 or permitting refrigerant flow to the chiller 112. This will simply circulate fluid around the battery circuit 60 thereby balancing the temperatures between the battery packs 16a and 16b.

Reference is made to FIG. 3, which shows a graph of battery pack temperature vs. time to highlight several of the rules which the controller 78 (FIG. 2) follows. In situations where the vehicle is on-plug and the battery packs 16a and 16b are below a selected minimum charging temperature Tcmin (FIG. 3), the controller 78 will heat the battery packs 16a and 16b prior to charging them. Once the battery packs 16a and 16b reach the minimum Charging temperature Tcmin, some of the power from the electrical source may be used to charge the battery packs 16a and 16b, and some of the power from the electrical source may continue to be used to heat them. When the battery packs 16a and 16b reach a minimum charge only temperature Tcomin, the controller 78 may stop using power from the electrical source to heat the battery packs 16a and 16b and may thus use all the power from the electrical source to charge them. Tcmin may be, for example, about −35 degrees Celsius and Tcomin may be, for example, about −10 degrees Celsius.

While charging, the controller 78 may precondition the battery packs 16a and 16b for operation of the vehicle. Thus, the controller 78 may bring the battery packs 16a and 16b to a desired minimum operating temperature Tomin while on-plug and preferably during charging.

In situations where the vehicle is on-plug and the battery packs 16a and 16b are above a selected maximum charging temperature Tcmax, the controller 78 will cool the battery packs 16a and 16b prior to charging them. Once the battery packs 16a and 16b come down to the maximum charging temperature Tcmax, power from the electrical source may be used to charge them, while some power may be required to operate the compressor 30 and other components in order to maintain the temperatures of the battery packs 16a and 16b below the temperature Tcmax. Tcmax may be, for example, about 30 degrees Celsius.

The battery packs 16a and 16b may have a maximum operating temperature Tomax that is the same or higher than the maximum charging temperature Tcmax. As such, when the battery packs 16a and 16b are cooled sufficiently for charging, they are already pre-conditioned for operation. In situations where the maximum operating temperature Tomax is higher than the maximum charging temperature Tcmax, the temperatures of the battery packs 16a and 16b may be permitted during operation after charging to rise from the temperature Tcmax until they reach the temperature Tomax.

The maximum and minimum operating temperatures Tomax and Tomin define a preferred operating range for the battery packs 16a and 16b. In situations where the battery packs 16a and 16b are below minimum operating temperature or above their maximum operating temperature, the vehicle may still be used to some degree. Within selected first ranges shown at 150 and 152 (based on the nature of the battery packs 16a and 16b) above and below the preferred operating range the vehicle may still be driven, but the power available will be somewhat limited. Within selected second ranges shown at 154 and 156 above and below the selected first ranges 150 and 152, the vehicle may still be driven in a limp home mode, but the power available will be more severely limited. Above and below the selected second ranges, the battery packs 16a and 16b cannot be used. The lower first range 150 may be between about 10 degrees Celsius and about −10 degrees Celsius and the upper first range 152 may be between about 35 degrees Celsius and about 45 degrees Celsius. The lower second range 154 may be between about −10 degrees Celsius and about −35 degrees Celsius. The upper second range may be between about 45 degrees Celsius and about 50 degrees Celsius.

It will be noted that the pumps 70, 86 and 106 are variable flow rate pumps. In this way they can be used to adjust the flow rates of the heat exchange fluid through the motor circuit 56, the cabin heating circuit 58 and the battery circuit 60. By controlling the flow rate generated by the pumps 70, 86 and 106, the amount of energy expended by the thermal management system 10 can be adjusted in relation to the level of criticality of the need to change the temperature in one or more of the thermal loads.

Additionally, the compressor 30 is also capable of variable speed control so as to meet the variable demands of the HVAC system 46 and the battery circuit 60.

Throughout this disclosure, the controller 78 is referred to as turning on devices (for example, the battery circuit heater 108, the chiller 112), turning off devices, or moving devices (for example, valve 88) between a first position and a second position. It will be noted that, in some situations, the device will already be in the position or the state desired by the controller 78, and so the controller 78 will not have to actually carry out any action on the device. For example, it may occur that the controller 78 determines that the chiller heater 108 needs to be turned on. However, the heater 108 may at that moment already be on based on a prior decision by the controller 78. In such a scenario, the controller 78 obviously does not actually ‘turn on’ the heater 108, even though such language is used throughout this disclosure. For the purposes of this disclosure and claims, the concepts of turning on, turning off and moving devices from one position to another are intended to include situations wherein the device is already in the state or position desired and no actual action is carried out by the controller on the device.

While the above description constitutes a plurality of embodiments of the present invention, it will be appreciated that the present invention is susceptible to further modification and change without departing from the fair meaning of the accompanying claims.

1. A thermal management system for an electric vehicle, the electric vehicle including a traction motor and a passenger cabin, comprising:
a motor circuit for cooling a motor circuit thermal load including the traction motor, wherein the motor circuit thermal load has a motor circuit thermal load inlet and a motor circuit thermal load outlet, wherein the motor circuit includes a radiator, a first motor circuit conduit fluidically between the radiator and the motor circuit thermal load inlet, a second motor circuit conduit fluidically between the radiator and the motor circuit thermal load outlet, and a motor circuit pump positioned to pump fluid through the motor circuit;
a cabin heating circuit for heat exchange with a cabin heating circuit thermal load which includes a cabin heater for heating the cabin, the cabin heating circuit thermal load having a cabin heating circuit thermal load inlet and a cabin heating circuit thermal load outlet, a first cabin heating circuit conduit fluidically between the motor circuit and the cabin heating circuit thermal load inlet, a second cabin heating circuit conduit fluidically between the cabin heating circuit thermal load outlet and the motor circuit, a third cabin heating circuit conduit fluidically between the second and first cabin heating circuit conduits, a cabin heating circuit heater positioned to heat fluid in the cabin heating circuit, a cabin heating circuit valve positionable in a first position wherein fluid flow between the motor circuit and the cabin heating circuit is substantially prevented and a second position wherein fluid flow between the motor circuit and the cabin heating circuit is permitted, and a cabin heating circuit pump positioned to pump fluid through the cabin heating circuit;
a motor circuit temperature sensor positioned to detect the temperature of fluid in the second motor circuit conduit; and
a controller operatively connected to the cabin heating circuit valve, the cabin heating circuit heater and to the cabin heating circuit pump, wherein the controller is programmed such that when the cabin heating circuit thermal load requires heat and the temperature sensed by the motor circuit temperature sensor is sufficiently high the controller turns off the cabin heating circuit heater and moves the cabin heating circuit valve to the second position, and when the cabin heating circuit thermal load requires heat and the temperature sensed by the motor circuit temperature sensor is sufficiently low the controller turns on the cabin heating circuit heater, operates the cabin heating circuit pump and moves the cabin heating circuit valve to the first position.

2. A thermal management system as claimed in claim 1, wherein the cabin heating circuit heater is positioned upstream of the cabin heating circuit thermal load inlet.

3. A thermal management system as claimed in claim 2, further comprising a cabin heating circuit temperature sensor positioned to detect the temperature of fluid downstream from the cabin heating circuit heater and wherein the controller is operatively connected to the cabin heating circuit pump.

4. A thermal management system as claimed in claim 1, wherein the controller is programmed to activate the cabin heating circuit heater based on the difference between the temperature of fluid from the second motor circuit conduit and a temperature setting from a climate control system in the passenger cabin.

5. A thermal management system as claimed in claim 1, wherein the motor circuit further includes a radiator bypass valve positioned in the second motor circuit conduit downstream from the cabin heating circuit valve, and a third motor circuit conduit fluidically between the radiator bypass valve and the first motor circuit conduit.

6. A thermal management system as claimed in claim 1, wherein the motor circuit thermal load includes a transmission control module, and wherein the transmission control module receives electrical current from a high voltage bus and sends a plurality of selected electrical currents to a plurality of destinations.

7. A thermal management system as claimed in claim 6, wherein the motor circuit thermal load further includes a DC/DC converter, and wherein the DC/DC converter receives electrical current at a first voltage from the transmission control system and outputs an electrical current at a second voltage.

8. A thermal management system as claimed in claim 6, wherein the cabin heating circuit pump is positioned in the third cabin heating circuit conduit.

9. A thermal management system for an electric vehicle, the electric vehicle including a traction motor and at least one battery pack, the thermal management system comprising;
a motor circuit for cooling a motor circuit thermal load including the traction motor, wherein the motor circuit thermal load has a motor circuit thermal load inlet and a motor circuit thermal load outlet, wherein the motor circuit includes a radiator, a first motor circuit conduit fluidically between the radiator and the motor circuit thermal load inlet, a second motor circuit conduit fluidically between the radiator and the motor circuit thermal load outlet, and a motor circuit pump positioned to pump fluid through the motor circuit;
a battery circuit for controlling the temperature of a battery circuit thermal load which includes the at least one battery pack, wherein the battery circuit thermal load has a battery circuit thermal load inlet and a battery circuit thermal load outlet, wherein the battery circuit includes a first battery circuit conduit fluidically between the motor circuit and the battery circuit thermal load inlet, a second battery circuit conduit fluidically between the battery circuit thermal load outlet and the motor circuit, a third battery circuit conduit fluidically between the second battery circuit conduit and the first battery circuit conduit, a battery circuit heater positioned to heat fluid in the battery circuit, a battery circuit valve positionable in a first position wherein fluid flow between the motor circuit and the battery circuit is substantially prevented and a second position wherein fluid flow between the motor circuit and the battery circuit is permitted, and a battery circuit pump positioned to pump fluid through the battery circuit;
a motor circuit temperature sensor positioned to detect the temperature of fluid in the second motor circuit conduit; and
a controller operatively connected to the battery circuit valve, the battery circuit heater and to the battery circuit pump, wherein the controller is programmed such that when heating of the battery circuit thermal load is required and the temperature sensed by the motor circuit temperature sensor is sufficiently high the controller turns off the battery circuit heater and moves the battery circuit valve to the second position, and when heating of the battery circuit thermal load is required and the temperature sensed by the motor circuit temperature sensor is sufficiently low the controller turns on the battery circuit heater, operates the battery circuit pump and moves the battery circuit valve to the first position.

10. A thermal management system as claimed in claim 9, wherein the battery circuit heater is positioned upstream of the battery circuit thermal load inlet.

11. A thermal management system as claimed in claim 9, wherein the controller is programmed to activate the battery circuit heater based on the difference between the temperature of fluid from the second motor circuit conduit and a target temperature for the battery circuit thermal load.

12. A thermal management system as claimed in claim 9, further comprising a battery circuit chiller positioned in the battery circuit upstream from the battery circuit thermal load.

13. A thermal management system as claimed in claim 9, further comprising a battery circuit temperature sensor positioned in the second battery circuit conduit, wherein the controller is programmed to control the operation of the battery circuit heater and the battery circuit valve based in part on the temperature sensed by the battery circuit temperature sensor.

14. A thermal management system as claimed in claim 9, wherein the battery circuit thermal load includes a battery charge control module, wherein when the vehicle is plugged into an electrical source the battery charge control module receives energy from the electrical source and processes the energy for storage in the battery pack, wherein when the at least one battery pack is below a selected battery pack temperature and the vehicle is plugged into an energy source the controller is programmed to position the battery circuit valve in the second position wherein heat generated in the battery charge control module heats fluid passing through therethrough, wherein the fluid is circulated to the at least one battery pack to heat the at least one battery pack.

15. A thermal management system as claimed in claim 9, wherein the motor circuit further includes a radiator bypass valve positioned in the second motor circuit conduit, a third motor circuit conduit fluidically between the radiator bypass valve and the first motor circuit conduit.

16. A thermal management system as claimed in claim 9, wherein the cabin heating circuit pump is positioned in the third cabin heating circuit conduit.

17. A thermal management system for an electric vehicle, the electric vehicle including a traction motor, a passenger cabin and at least one battery pack, the thermal management system comprising:
a motor circuit for cooling a motor circuit thermal load including the traction motor, wherein the motor circuit thermal load has a motor circuit thermal load inlet and a motor circuit thermal load outlet, wherein the motor circuit includes a radiator, a first motor circuit conduit fluidically between the radiator and the motor circuit thermal load inlet, a second motor circuit conduit fluidically between the radiator and the motor circuit thermal load outlet, and a motor circuit pump positioned to pump fluid through the motor circuit;
a cabin heating circuit for heat exchange with a cabin heating circuit thermal load which includes a cabin heater for heating the cabin, the cabin heating circuit thermal load having a cabin heating circuit thermal load inlet and a cabin heating circuit thermal load outlet, a first cabin heating circuit conduit fluidically between the motor circuit and the cabin heating circuit thermal load inlet, a second cabin heating circuit conduit fluidically between the cabin heating circuit thermal load outlet and the motor circuit, a third cabin heating circuit conduit fluidically between the second and first cabin heating circuit conduits, a cabin heating circuit heater positioned to heat fluid in the cabin heating circuit, a cabin heating circuit valve positionable in a first position wherein fluid flow between the motor circuit and the cabin heating circuit is substantially prevented and a second position wherein fluid flow between the motor circuit and the cabin heating circuit is permitted, and a cabin heating circuit pump positioned to pump fluid through the cabin heating circuit;
a battery circuit for controlling the temperature of a battery circuit thermal load which includes the at least one battery pack, wherein the battery circuit thermal load has a battery circuit thermal load inlet and a battery circuit thermal load outlet, wherein the battery circuit includes a first battery circuit conduit fluidically between the second motor circuit conduit upstream from the radiator and the battery circuit thermal load inlet, a second battery circuit conduit fluidically between the battery circuit thermal load outlet and the first motor circuit conduit, a third battery circuit conduit fluidically between the second battery circuit conduit and the first battery circuit conduit, a battery circuit heater positioned to heat fluid in the battery circuit, a battery circuit valve positionable in a first position wherein fluid flow between the motor circuit and the battery circuit is substantially prevented and a second position wherein fluid flow between the motor circuit and the battery circuit is permitted, and a battery circuit pump positioned to pump fluid through the battery circuit;
a motor circuit temperature sensor positioned to detect the temperature of fluid in the second motor circuit conduit; and
a controller operatively connected to the cabin heating circuit valve to control the flow of fluid between the motor circuit and the cabin heating circuit and operatively connected to the battery circuit valve to control the flow of fluid between the motor circuit and the battery circuit, such that heat transferred to fluid in the motor circuit by the motor circuit thermal load is removed from the fluid by at least one of the group selected from the cabin heating circuit thermal load, the battery circuit thermal load and the radiator.

18. A thermal management system for an electric vehicle, the electric vehicle including a traction motor and at least one battery pack, the thermal management system comprising:
a battery circuit for controlling the temperature of a battery circuit thermal load including the at least one the battery pack including a battery circuit thermal load inlet and a battery circuit thermal load outlet, wherein the battery circuit includes a first battery circuit conduit extending to the battery circuit thermal load inlet, a second battery circuit conduit from the battery circuit thermal load outlet, a third battery circuit conduit fluidically between the second battery circuit conduit and the first battery circuit conduit, and a battery circuit pump in the first battery circuit conduit configured to pump fluid through the battery circuit;
a battery charge control module, wherein when the vehicle is plugged into an electrical source the battery charge control module receives energy from the electrical source and processes the energy for storage in the at least one battery pack, wherein when the at least one battery pack is below a selected battery pack temperature and the vehicle is plugged into an electrical source the controller is programmed to position the battery circuit valve in the second position wherein heat generated in the battery charge control module heats fluid passing through therethrough, wherein the fluid is circulated to the at least one battery pack to heat the at least one battery pack; and
a battery circuit heater positioned to heat fluid in the battery circuit, wherein the battery circuit heater is configured to operate with an inlet voltage of 12VDC.

19. A thermal management system as claimed in claim 18, further comprising a motor circuit for cooling a motor circuit thermal load including the traction motor, wherein the motor circuit thermal load has a motor circuit thermal load inlet and a motor circuit thermal load outlet, wherein the motor circuit includes a radiator, a first motor circuit conduit fluidically between the radiator and the motor circuit thermal load inlet, a second motor circuit conduit fluidically between the radiator and the motor circuit thermal load outlet, and a motor circuit pump positioned to pump fluid through the motor circuit,
wherein the first and second battery circuit conduits connect to the motor circuit; and
wherein the battery circuit includes a battery circuit valve positionable in a first position wherein fluid flow between the motor circuit and the battery circuit is substantially prevented and a second position wherein fluid flow between the motor circuit and the battery circuit is permitted, and wherein the battery circuit valve is configurable in a first configuration for sending fluid from the battery pack outlet to the first motor circuit conduit, and is configurable in a second configuration for sending fluid from the battery pack outlet to the third battery circuit conduit.

20. A thermal management system for an electric vehicle, the electric vehicle including a traction motor and at least one battery pack, the thermal management system comprising:
a motor circuit for cooling a motor circuit thermal load including the traction motor, wherein the motor circuit thermal load has a motor circuit thermal load inlet and a motor circuit thermal load outlet, wherein the motor circuit includes a radiator, a first motor circuit conduit fluidically between the radiator and the motor circuit thermal load inlet, a second motor circuit conduit fluidically between the radiator and the motor circuit thermal load outlet, and a motor circuit pump positioned to pump fluid through the motor circuit;
a battery circuit for controlling the temperature of a battery circuit thermal load which includes the at least one battery pack, wherein the battery circuit thermal load has a battery circuit thermal load inlet and a battery circuit thermal load outlet, wherein the battery circuit includes a first battery circuit conduit fluidically between the second motor circuit conduit upstream from the radiator and the battery circuit thermal load inlet, a second battery circuit conduit fluidically between the battery circuit thermal load outlet and the first motor circuit conduit, a third battery circuit conduit fluidically between the second battery circuit conduit and the first battery circuit conduit, a chiller positioned to cool fluid in the battery circuit, the chiller having a refrigerant inlet and a refrigerant outlet, a battery circuit valve positionable in a first position wherein fluid flow between the motor circuit and the battery circuit is substantially prevented and a second position wherein fluid flow between the motor circuit and the battery circuit is permitted, and a battery circuit pump positioned to pump fluid through the battery circuit;
a main cooling circuit including a compressor, a first cooling circuit conduit positioned upstream of the compressor and positioned for receiving refrigerant from the refrigerant outlet of the evaporator and for receiving refrigerant from the refrigerant outlet of the chiller, a condenser positioned downstream from the compressor, a second cooling circuit conduit positioned downstream of the condenser and positioned for delivering refrigerant to the refrigerant inlet of the chiller and to the refrigerant inlet of the evaporator and a chiller refrigerant flow control valve positioned for controlling the flow of refrigerant through the chiller;
a motor circuit temperature sensor positioned to detect the temperature of fluid in the second motor circuit conduit; and
a controller operatively connected to the chiller refrigerant flow control valve, the evaporator refrigerant flow control valve, the battery circuit valve, the battery circuit pump and the compressor, wherein the controller is programmed to open the chiller refrigerant flow control valve based on a comparison of the temperature sensed by the motor circuit temperature sensor and a target temperature for the battery circuit thermal load, and to open the evaporator refrigerant flow control valve based on a temperature setting of a climate control system for the passenger cabin.

21. A thermal management system as claimed in claim 20, wherein the vehicle includes a passenger cabin and an evaporator for controlling the temperature of the passenger cabin, the evaporator having a refrigerant inlet and a refrigerant outlet, and wherein the thermal management system includes an evaporator refrigerant flow control valve positioned for controlling the flow of refrigerant through the evaporator, wherein the controller is operatively connected to the evaporator refrigerant flow control valve.

22. A thermal management system as claimed in claim 21, wherein the chiller refrigerant flow control valve and the evaporator refrigerant flow control valve are the same valve.
